(19) United States
(12) Patent Application Publication
(10) Pub. No.: US 2026/0002567 A1
(43) Pub. Date: Jan. 1, 2026

(54) BRAKE CALIPER

(71) Applicant: SRAM, LLC, CHICAGO, IL (US)

(72) Inventor: BRADEN SNEAD, COLORADO SPRINGS, CO (US)

(73) Assignee: SRAM, LLC, CHICAGO, IL (US)

(21) Appl. No.: 18/755,968

(22) Filed: Jun. 27, 2024

(51) Int. Cl. F16D 65/00; F16D 65/18; F16D 121/14

(52) U.S. Cl. CPC F16D 65/0068; F16D 65/18; F16D 2121/14

(57) ABSTRACT

A brake caliper includes a caliper housing having a cavity, a piston reciprocally moveable in the cavity between a non-braking position and a braking position. A seal is disposed between the piston and an interior surface of the cavity. A gripping member is engaged with the piston and spaced apart from the interior surface of the cavity. The gripping member abuts a stop when the piston is in the non-braking position and is spaced apart from the stop when the piston is in the braking position. A biasing member biases the gripping member and piston from the braking position to the non-braking position.

### FIELD OF THE DISCLOSURE

The present application generally relates to a brake caliper, including for example and without limitation a brake caliper used on a bicycle.

### BACKGROUND

Bicycles may include hydraulic brake systems incorporating hydraulic brake calipers. Hydraulic brake calipers may be configured with one or more pistons that move one or more brake pads toward a brake rotor. The piston is typically housed within a bore, or cavity, of a caliper housing. Typically, a single seal is disposed between the piston and a caliper housing. The seal may be captured in a gland formed in the housing. The seal, which may have a rectangular cross section, may flex with the movement of the piston as the piston is actuated, with the seal then biasing the piston in the opposite direction to release the brake pad, otherwise referred to as a “rollback” function. As the brake pads wear over time, the piston is required to actuate a further distance in order for the brake pads to make adequate contact with the rotor. When the piston exceeds the flex range of the seal, the piston may slide relative to the seal in order to advance during braking. The combination of requiring the seal to both flex and slide may provide inconsistent rollback. In addition, if the worn brake pads are replaced with new, thicker brake pads, then the typical single seal system may require additional tools and installation effort to properly return the piston and seal to an initial setting such that the seal may again provide proper rollback to the piston and associated brake pad.

The seal is typically made of rubber, or viscoelastic material, which has inherent damping characteristics that may be affected by environmental factors such as temperature, pressure, etc. These mechanical properties may also vary and evolve over time due to compression set, heat set, abrasion wear, etc. This variation may adversely affect the ability to reliably control the piston rollback, especially in systems where the brake has a relatively short amount of lever throw combined with a need to avoid rubbing of the pads on the brake rotor. While the rollback may be adjusted by changing the geometry of the gland or seal, the rollback function depends on maintaining consistent friction between the seal and piston. Without any friction, the piston would simply slide relative to the bore to a brake engaging position and stay there when the brake is disengaged. With too much friction, the piston may not be able to slide relative to the seal to account for pad wear, and piston movement may potentially damage the seal. Because the seal material properties may be changing over time, particularly in response to environmental and use conditions, the tuning and optimization of the seal and gland configuration is made even more difficult.

Consistency of rollback, both in the short term and long term, is important to the rider. The viscoelastic properties of the seal material may result in hysteresis of the seal movement as the seal retracts the piston into the bore at the end of a brake application. Comparatively, a piston in the lever assembly may be driven back to an initial position via a metal compression spring, which is minimally affected by environmental factors. Typically, brake systems are configured as an ‘open’ design, meaning that when the brake is not engaged, the system is connected to a reservoir containing a diaphragm. The reservoir allows for the system to automatically compensate for wear of the brake pads over time, for example by allowing fluid from the reservoir to flow into the caliper to take up the volume resulting from the piston(s) advancing due to the pad wear. Such open systems, when coupled with the uneven retraction speed of the caliper and lever pistons, may create problems when the brake lever is engaged and released multiple times in quick succession. In this situation, the lever piston returns to the fully released position before the caliper piston returns to a non-braking position, causing fluid to move through the timing port into the lever bore. Because the lever piston may begin the next actuation before the caliper piston has fully retracted, the caliper piston have less distance to travel before the pads engage the rotor and braking action occurs. This may also lead to a decrease in the amount of lever throw. During a sequence of frequent, repeated pulls on the lever, the engagement point (i.e. dead-band) of the lever will move further and further from the handlebar. This effect may lead to a lack of consistency for the user. As the ratio between the lever and caliper pistons increases, this variation may become even more pronounced.

Decreasing the nominal amount of rollback of the caliper piston may decrease the degree of lever outward movement. Eventually, however, the pad-to-rotor clearance will become small enough that rubbing between the pad and rotor may become a problem. Rubbing may be particularly problematic and undesirable for a bicycle rider since the power to drive the vehicle derives at least in part from the rider. As the ambient temperature decreases, the viscoelastic damping in the rubber material, and corresponding adverse effect on the lever movement, may be exacerbated.

### SUMMARY

In one aspect, one embodiment of a brake caliper includes a caliper housing comprising a cavity defining a longitudinal axis. A piston is disposed in the cavity and reciprocally movable in the cavity along the longitudinal axis between a braking position and a non-braking position. A seal is disposed between the piston and the caliper housing. A gripping member is engaged with and disposed about the piston and longitudinally spaced from the seal. The gripping member is reciprocally movable with the piston along the longitudinal axis. A retainer is connected to the caliper housing and longitudinally spaced from the gripping member. The retainer retains the gripping member within the cavity. A biasing member is disposed between the retainer and the gripping member. The biasing member biases the gripping member towards the non-braking position.

In other aspects, methods of assembling and using the brake caliper are also provided.

The various aspects and embodiments of the brake caliper, and the methods for the adjustment and assembly thereof, provide significant advantages over other brake calipers and methods. For example and without limitation, the brake caliper does not rely on, or use, the seal, which may be susceptible to various environmental variabilities, as a primary rollback mechanism. Rather, the control functions may be carried out by the gripping and biasing members, which are separate components from the seal. Moreover, these members may be made of materials less susceptible to degradation and variability. In this way, the brake caliper reduces the variation in the rollback function across the range of manufacturing variabilities and in various environmental conditions. As such, improved rollback consistency may be achieved.

In the presently disclosed system, the components or features for (1) generating friction on the piston, (2) resisting the movement of the piston resulting from braking and (3) limiting the amount of piston movement before the piston is allowed to slip at the friction interface, are separated, such that the interdependency of these functions may be more effectively controlled. For example and without limitation, any friction applied to the piston is primarily controlled by the gripping member and piston, rather than the seal. The resistance to outward motion of the piston is controlled almost entirely by the biasing member, which may be optimized, for example by controlling the material properties and shape thereof. The retainer controls the amount of preload applied to the biasing member. The stack-up of the gripping member, retainer, and configuration/size/shape of the cavity may dictate the amount of allowable piston movement (rollback) before slip occurs. In this arrangement, each component may be individually designed and tuned to achieve a predetermined braking action. In one embodiment, the components, for example the gripping member and biasing member, may be made of hard, metallic material, which further reduces the variation in the rollback motion, regardless of environmental conditions and changes over time.

The foregoing paragraphs have been provided by way of general introduction and are not intended to limit the scope of the claims presented below. The various preferred embodiments, together with further advantages, will be best understood by reference to the following detailed description taken in conjunction with the accompanying drawings.

### BRIEF DESCRIPTION OF THE DRAWINGS

Objects, features, and advantages of the present invention will become apparent upon reading the following description in conjunction with the drawing figures, in which:

FIG. 1 is a side view of one embodiment of a bicycle assembled with a hydraulic brake system.

FIGS. 2A and B are partial side and end views of a portion of a bike frame and brake system.

FIGS. 3A and B are partial side and cross-sectional views of a portion of a bike frame and brake system.

FIG. 4 is an end view of one embodiment of a brake caliper.

FIG. 5 is a cross-sectional view of the brake caliper taken along lines 5-5 in FIG. 4.

FIG. 6 is an enlarged, partial view of the cross section taken along line 6 in FIG. 5.

FIG. 7 is an exploded view of the brake caliper shown in FIGS. 4-6.

FIGS. 8A-C are cross-sectional views of one embodiment of a brake caliper in an initial, engaged and final state.

FIGS. 9A-D are cross-sectional views of one embodiment of a brake caliper in an initial, piston slip initiated, piston slip end and final state.

FIG. 10 is an end view of one embodiment of a brake caliper.

FIG. 11 is a cross-sectional view of the brake caliper taken along lines 11-11 in FIG. 10.

FIG. 12 is an enlarged, partial view of the cross section taken along line 12 in FIG. 11.

FIG. 13 is an exploded view of the brake caliper shown in FIGS. 10-12.

FIG. 14 is an end view of one embodiment of a brake caliper.

FIG. 15 is a cross-sectional view of the brake caliper taken along lines 15-15 in FIG. 14.

FIG. 16 is an enlarged, partial view of the cross section taken along line 16 in FIG. 15.

FIG. 17 is an exploded view of the brake caliper shown in FIGS. 14-16.

FIG. 18 is an end view of one embodiment of a brake caliper.

FIG. 19 is a cross-sectional view of the brake caliper taken along lines 19-19 in FIG. 18.

FIG. 20 is an exploded view of the brake caliper shown in FIGS. 18 and 19.

FIG. 21 is an end view of one embodiment of a brake caliper.

FIG. 22 is a cross-sectional view of the brake caliper taken along lines 22-22 in FIG. 21.

FIG. 23 is an exploded view of the brake caliper shown in FIGS. 21 and 22.

FIG. 24 is an end view of one embodiment of a brake caliper.

FIG. 25 is a cross-sectional view of the brake caliper taken along lines 25-25 in FIG. 24.

FIG. 26 is an enlarged, partial view of the cross section taken along line 26 in FIG. 25.

FIG. 27 is an exploded view of the brake caliper shown in FIGS. 24-26.

FIG. 28 is a perspective view of one embodiment of a piston.

FIG. 29 is a cross-sectional view of the piston shown in FIG. 28 incorporated into a brake system.

FIG. 30 is a perspective view of one embodiment of a piston.

FIG. 31 is a cross-sectional view of the piston shown in FIG. 30 incorporated into a brake system.

FIG. 32 is a perspective view of one embodiment of a gripper member.

FIG. 33 is a side view of the gripper member shown in FIG. 32.

FIG. 34 is an enlarged, partial view of the gripper member taken along line 34 in FIG. 32.

FIG. 35 is a side view of another embodiment of a gripper member.

FIGS. 36A and B show different embodiments of a split biasing member.

FIGS. 37A and B shown different embodiments of a continuous biasing member.

FIGS. 38A, B and C shown different views of a Belleville spring biasing member.

FIGS. 39A, B and C show a perspective view, end view and side view of an integrated gripper member, biasing member and retainer.

FIGS. 40A, B and C show a perspective view, end view and side view of an integrated gripper member and biasing member.

FIGS. 41A, B and C show a perspective view, end view and side view of an integrated biasing member and retainer.

FIG. 42 is a graph showing deflection v. force for various components of the brake system.

### DETAILED DESCRIPTION OF THE DISCLOSURE

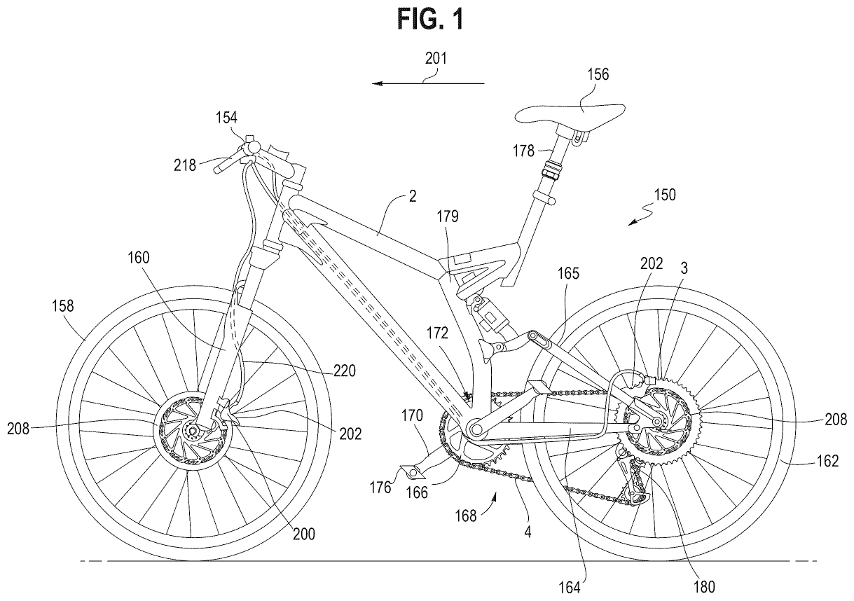

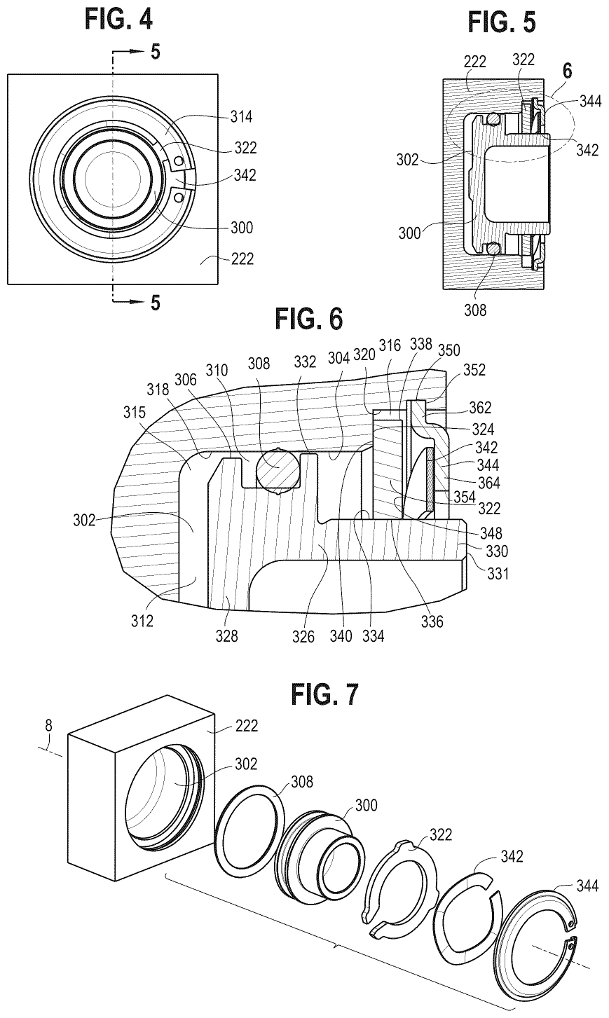

It should be understood that the term “plurality,” as used herein, means two or more. The term “longitudinal,” as used herein means of or relating to a length or lengthwise direction, including for example an axial direction 8. The term “lateral,” as used herein, means situated on, directed toward or running in a side-to-side. The term “coupled” means connected to or engaged with, whether directly or indirectly, for example with an intervening member, and does not require the engagement to be fixed or permanent, although it may be fixed or permanent. The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different, meaning for example a first direction may be the same as a second direction, with each simply being applicable to different components. The terms “upper,” “lower,” “rear,” “front,” “fore,” “aft,” “vertical,” “horizontal,” “right,” “left,” “inboard,” “outboard” and variations or derivatives thereof, refer to the orientations of an exemplary bicycle 150, shown in FIG. 1, from the perspective of a user seated thereon, for example with an “inboard” component or feature being closer to a vertical mid-plane of the bicycle. The term “transverse” means non-parallel. The terms “outer” and “outwardly” refers to a direction or feature facing away from a centralized location, for example the phrases “radially outwardly,” “radial direction” and/or derivatives thereof, refer to a feature diverging away from a centralized location, for example relative to an axial direction 8 as shown in FIG. 4. Conversely, the terms “inward” and “inwardly” refers to a direction facing toward the centralized or interior location. The term “subassembly” refers to an assembly of a plurality of components, with subassemblies capable of being further assembled into other subassemblies and/or a final assembly, such as the bicycle 150.

FIG. 1 illustrates one embodiment of a human powered vehicle. In the example shown, the vehicle is one possible type of bicycle 150, such as a mountain bicycle. It should be understood that the various embodiments of the hydraulic brake caliper may be used on other types of human powered vehicles, including for example and without limitation road bicycles. In FIG. 1, a normal riding or forward moving direction 201 of the bicycle 150 is shown. The bicycle 150 has a frame 2, handlebars 154 near a front end of the frame 2, brake levers 218 secured to the handlebars, and a seat or saddle 156 for supporting a rider over a top of the frame 2. The bicycle 150 has a first or front wheel 158 carried by a front fork 160 supporting the front end of the frame 2. The bicycle 150 also has a second or rear wheel 162 supporting a rear end of the frame 2, which includes a pair of chain stays 164 connected to a pair of seat stays 165 at a junction or apex. The bicycle 150 also has a drive train 168 with a crank assembly 166 that is operatively coupled via a bicycle chain 4 to a rear cassette 3, otherwise referred to as a driven sprocket assembly, near a hub providing a rotation axis of the rear wheel 162. The crank assembly 166 includes at least one, and typically two, crank arms 170 and pedals 176, along with a front chainring assembly 172, or drive sprocket assembly. A crank spindle or shaft may connect the two crank arms. The crank shaft defines a center rotational axis of the chainring assembly 172. The crank assembly may also include other components.

A rear gear change device, such as a rear derailleur 180, is disposed at the rear wheel 162 to move the bicycle chain 4 to different sprockets of the cassette 3. In one embodiment, a front gear changer device, or front derailleur, may be provided to move the chain 4 to different sprockets of the chainring assembly. In the illustrated example, the saddle 156 is supported on a seat post 178 having an end portion received in a top of a frame seat tube 179 of the frame 2.

Referring to FIGS. 1, 2A and 2B and 3A and 3B, a brake system 200 is coupled to the bicycle frame 2, for example the front fork 160, or the rear seat stay 165. The brake system 200 includes a caliper 202 secured to the frame, e.g., front fork 160, for example with a pair of bolts 204, and a rotor 208 secured to the front or rear wheel. The rotor 208 is rotatable relative to the caliper 202 and is disposed within a slot 210 defined by the caliper 202. Referring to FIGS. 4, 6 and 8-10, the caliper 202 includes a pair of opposing brake pads 212 that engage opposite first and second sides 214, 216 of the rotor 208 when actuated to slow and/or stop the rotation of the rotor, attached wheel and bicycle. The caliper 202 is in fluid connection with the brake lever 218 by way of a conduit 220, shown for example in FIGS. 1, 5 and 6. The brake lever 218 may be actuated (e.g., pulled) to increase the hydraulic pressure in the conduit 220 and thereby pressurize the caliper 202, and components therein, so as to actuate the brake pads 212 and move them into engagement with opposite sides 214, 216 of the rotor 208. Separate hydraulic systems may be provided for the front and rear wheels 158, 162 and calipers 202 associated with each wheel.

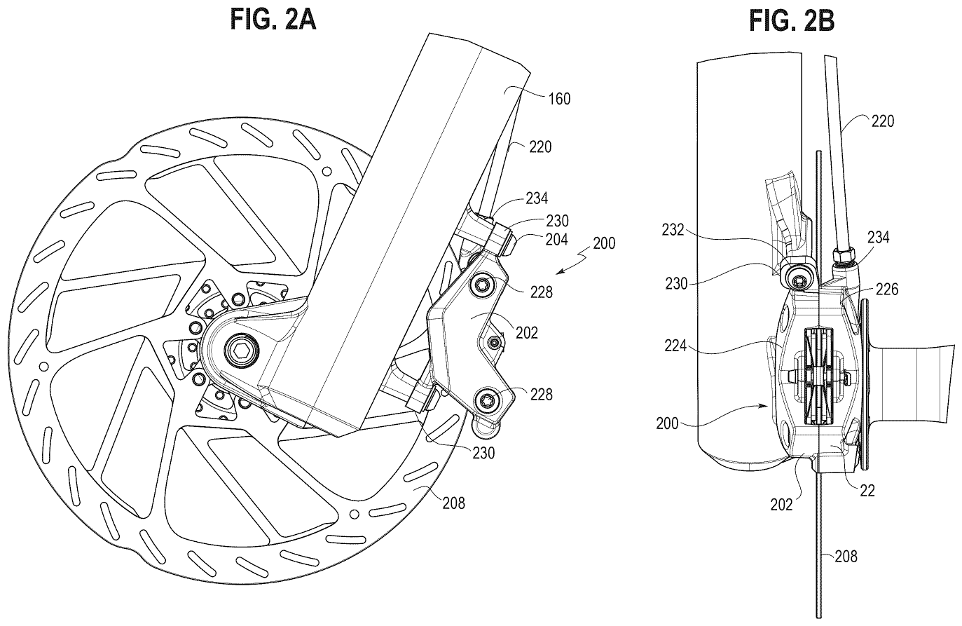

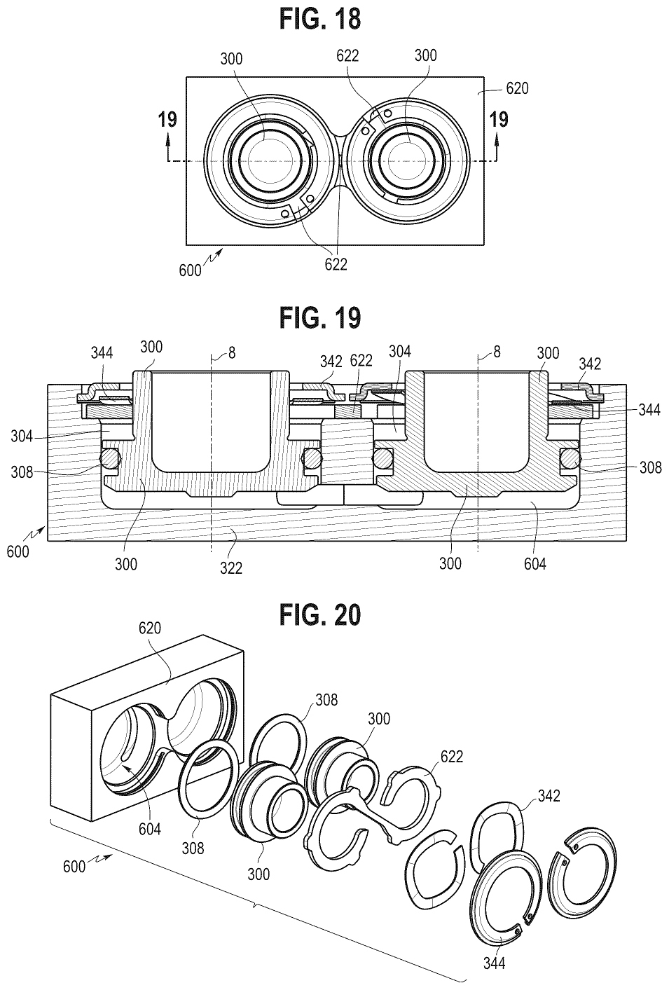

Referring to FIGS. 2A-27, the caliper 202 includes a housing 222, configured in one embodiment with an outboard caliper portion 224 and an inboard caliper portion 226, which are secured to each other to form and define the rotor slot 210. The caliper portions may be secured or coupled to each other, for example, with fasteners 228, shown as a pair of bolts. The caliper housing 222, including the outboard and inboard portions 224, 226, may be made from aluminum alloy, or other similar and/or suitable materials. The housing 222 includes a mounting arrangement 230, shown in one embodiment as a pair of platforms, which are configured to be mounted to a base components, including for example and without limitation a vehicle frame, fork 160, or chassis member. In one embodiment, the mounting arrangement 230 includes one or more mounting holes 232 located on the outboard caliper portion 224, with a pair of fasteners securing the housing to the base component. Other configurations of the mounting arrangement may include one or more of mounting holes, slots, threads, dovetail features, or clamping mechanisms, which may be used to mount the caliper to a vehicle member, and these configuration features may be disposed on either the inboard or the outboard caliper portion.

As shown in FIGS. 2A and 2B, the caliper housing 222 includes a fluid inlet having a port 234, configured with a fitting in one embodiment, in fluid communication with the conduit for communicating hydraulic fluid to and from the hydraulic pump or master cylinder actuated by the lever 218. The fluid inlet, or port 234 is in fluid communication with a piston 242 disposed in the housing 222 for unrestricted fluid flow to the piston.

In one embodiment, the caliper 202 may include an actuating inboard caliper portion and a non-actuating outboard caliper portion. The actuating and non-actuating caliper portions may also be switched to the outboard and inboard portions respectively. In other embodiments, shown for example in FIGS. 2A, 2B, 5 and 6, the caliper may include both inboard and outboard caliper portions 224, 226 with an actuating function. In one embodiment, the fasteners 228 slide through the outboard caliper portion 224 and threadably engage the inboard caliper portion 226 to create the caliper housing 222. Conversely, the bolts may slide through the inboard caliper portion and threadably engage the outboard caliper portion. The inboard caliper portion 226 and outboard caliper portion 224 may also be fastened to one another with screws, bolts, rivets, or welding, or may be configured as a single unitary piece. In one embodiment, which includes only a single actuating caliper portion, the non-actuating portion, e.g., outboard caliper portion 224, is not configured with any hydraulic chambers, cylinders, or features, and when assembled one brake pad may be disposed on a flat, inside surface of the caliper portion.

Referring to FIGS. 2A-6, the brake caliper 202 is mounted to the fork 160 with the fasteners, e.g., bolts 204. The wheel 158, 162, including a hub configured with the rotor 208, is mounted to the fork axle. The rotor 208 passes rotationally through the rotor slot 210 of the caliper. The conduit 220 is connected to and extends from the caliper 202, and provides a hydraulic connection to the brake lever assembly 218, which provides for the displacement of brake fluid within the caliper.

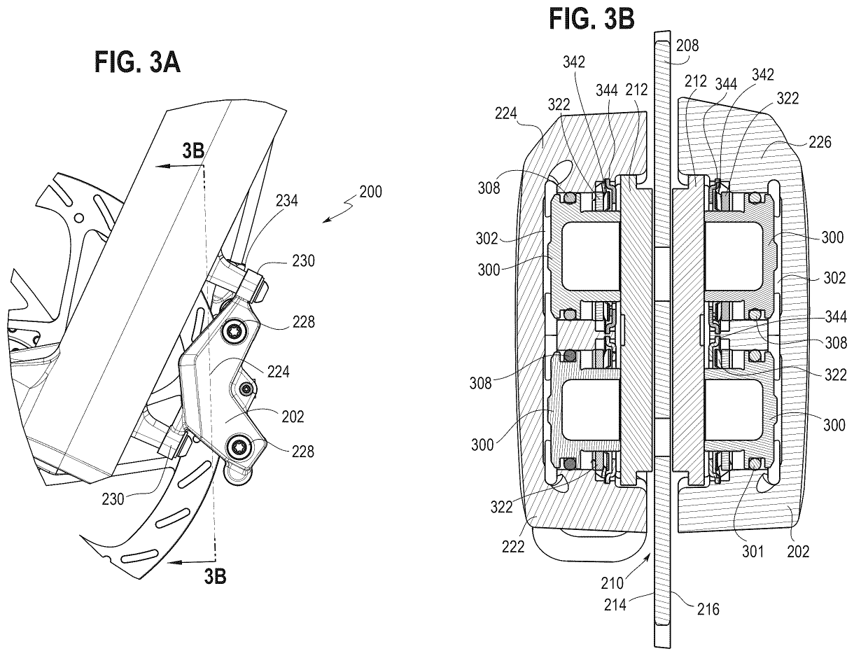

As shown in FIG. 3B, brake pads 212 are located on both sides of the rotor 208. Each brake pad 212 is held against a pair of pistons 300, which may be different sizes. In one embodiment, the piston 300 and caliper housing 222 are made of metal. In one embodiment, the pistons 300 opposing each on opposite sides of the rotor 208 are the same size, while the laterally spaced, adjacent pistons, and corresponding rollback mechanisms, on either side are different sizes, meaning they have different diameters. Each piston 300 is fitted into a bore, or cavity 302 defined by the housing 222. The cavity 302 defines an interior surface 304 and a longitudinal axis, or axial direction 8 along which the piston 300 is reciprocally moveable. The piston 300 is disposed in the cavity 302 and has an exterior surface 306. The piston 300 is reciprocally moveable in the cavity 302 relative to the caliper housing 222 along the longitudinal axis, or axial direction 8, between a non-braking position and a braking position. A seal 308 is disposed between the exterior surface 306 of the piston and the interior surface 304 of the cavity, or bore. In one embodiment, the exterior surface 306 of the piston may be configured with a circumferential groove, or seal gland 310, in which the seal 308 is disposed. In other embodiments, the caliper housing may be configured with a seal gland. The seal 308 may be configured as a elastomeric ring, such as an O-ring, or may have other suitable cross-sectional shapes. In one embodiment, the seal is made of rubber, or other elastomeric materials.

The seal 308 retains and prevents brake fluid 312, which communicates with a face 314 of the piston, from leaking out of the caliper. The assembly is configured such that when displacement of the brake fluid 312 is produced by the lever assembly 218, the fluid 312 pushes against the face(s) 314 of the piston(s), forcing the piston(s) 300 inwardly and thereby pushing the brake pads 212 against the rotor 208. In one embodiment, the seal 308 does not apply any significant return force to the piston, or otherwise perform a roll-back function. The friction interface between the brake pads 212 and rotor 208 generates a force that results in a torque applied through the rotor to the hub, to slow the vehicle. A rollback mechanism interfaces between the piston 300 and caliper housing 222 for retracting, or rolling back, each piston, such that when the brake lever 218 releases, the pistons 300 are returned to an original, non-braking position.

In one embodiment, the caliper housing cavity 302 has a first portion 315 and a second portion 316. The interior surface 304 includes a first interior surface 318 defined by the first portion and a second interior surface 320 defined by the second portion. In one embodiment, the first interior portion 315 has a first diameter less than a second diameter of the second interior portion 316 portion. The first and second interior portions may be round or non-round. The seal 308 is disposed between the exterior surface 306 of the piston and the interior surface 318 of the first portion. A gripping member 322 is disposed in the second interior portion 316. The second interior portion 316 includes or defines a wall or surface that defines a stop 324.

The piston 300 has a main body 326 defining a first portion 328 having a first diameter and a second portion 330 having a second diameter. The exterior surface 306 includes a first exterior surface 332 defined by the first portion and a second exterior surface 334 defined by the second portion. In one embodiment, the first portion 328 has a first diameter greater than a second diameter of the second portion 330. The seal gland 310 is formed in, and extends radially inwardly from, the first exterior surface 332 in one embodiment. The seal 308 is disposed between the first exterior surface 332 and the interior surface 304, e.g., the interior surface 318 of the first portion. The gripping member 322, configured in one embodiment as a ring, engages the second exterior surface 334.

In one embodiment, the gripping member 322 includes an inner peripheral edge 336 engaged with the exterior surface 334 of the piston, an outer peripheral edge 338 spaced apart from the interior surface 318 of the cavity and a face 340, wherein the face 340 abuts the stop 324 when the piston is in the non-braking position and wherein the face 340 is spaced apart from the stop 324 when the piston is in the braking position. In one embodiment, the gripping member 322 is made of metal, such as steel, ferrous alloy, super alloys, titanium, titanium alloys, aluminum, aluminum alloys and various other heat treatable metals. In other embodiments, the gripping member may be made of high temperature non-metals such as graphite, carbon or silicon composites. A biasing member 342 biases the gripping member 322 and piston 300 from the braking position to the non-braking position or towards the non-braking position. In one embodiment, a retainer 344 is connected to the caliper housing 222, with the biasing member 342 disposed between the retainer 344 and the gripping member 322. The gripping member, biasing member and the retainer may be disposed about the exterior surface of the piston.

As mentioned, the smaller diametrical portion 330 of the piston is engaged by the gripping member 322, and an inner peripheral edge 364 in particular. The gripping member 322 may be configured as a ring, for example a split ring, which may be expanded and engaged with the exterior surface 334. The expansion of the gripping member 322 creates a normal force acting between the gripping member 322 and piston 300 to provide a corresponding friction force that resists sliding of the gripping member 322 along the exterior surface 334 in opposition to the normal force until such time as a predetermined force is applied so as to reposition the gripping member 322 as further explained below. One face 340 of the gripping member abuts the stop 324, shown as a wall surface or shelf defining in part the second portion 316 of the cavity 302. The wall or shelf transitions between the larger and smaller diametrical section of the cavity 302. An opposite face 348 of the gripping member 322 abuts the biasing member 342. The phrase “biasing member” refers to a member that may be displaced, deflected or deformed, but which applies a force in the direction of the deflection or deformation.

The biasing member 342 may be configured as a spring, including a compression spring, tension spring, leaf spring, or other suitable spring, including various elastomeric members or bladders. In one embodiment, the biasing member 342 is configured as a wave spring as shown in the figures. The wave spring may be made from a metal strip that is rolled or formed into a circular shape with an undulating wave pattern. The wave spring is compressed against the gripping member 322 and secured by the retainer 344.

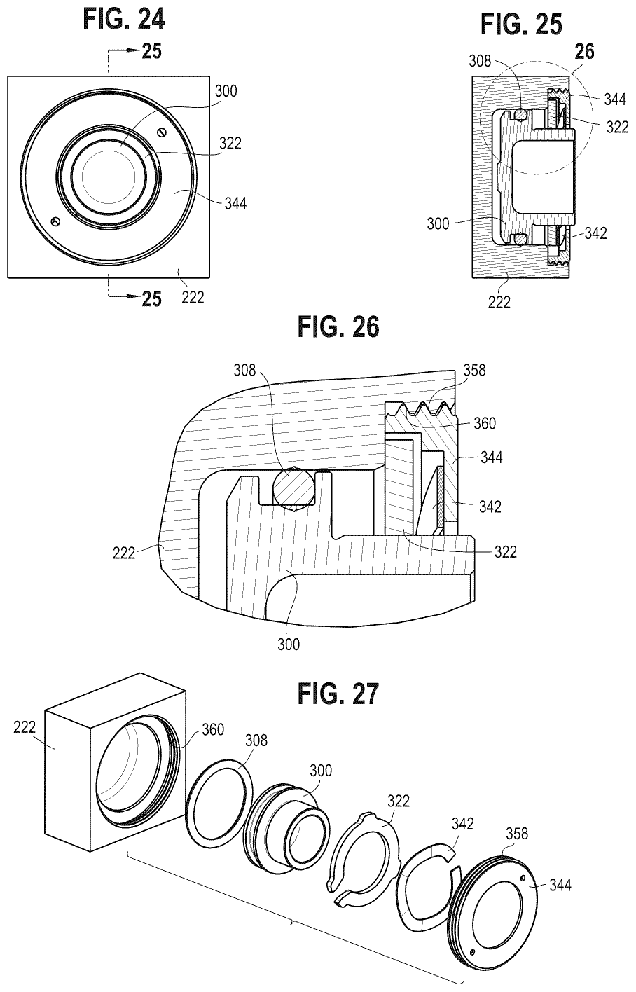

The retainer 344, which may be configured as a ring, is connected to the caliper housing 222, with the biasing member 342 disposed between the retainer and the gripping member. The retainer is axially fixed to the housing 222. The caliper housing may include a radially extending slot 350, configured for example as a circumferentially extending slot, or a groove having a greater diameter than the second exterior portion of the cavity. The retainer 344 may be configured with an outer peripheral edge 352, which is disposed in the slot 350 so as to axially fix the location of the retainer. The retainer 344 has an inner peripheral edge 354 spaced apart from the exterior surface 334 of the piston, such that the retainer 344 does not apply any frictional force to the piston 300. The retainer 344 may be configured as a ring, including in one embodiment an open, or split ring. The ring may also be continuous as shown in FIG. 27. In one embodiment, the retainer 344 has a threaded outer periphery 358, which may be threadably engaged with a threaded inner peripheral surface 360 of the caliper housing 222 as shown in FIGS. 24-27. The retainer 344, i.e., retaining ring, may be configured with a cross-section profile having an edge portion 362 offset in the axial direction 8 of the cavity, with an inner diametrical region 364 abutting the biasing member 342 and the outer diametrical edge portion 362 disposed in, or secured into, the circumferential slot 350, or gland, defined in the caliper body.

The inner peripheral edge 336 of the gripping member 322 is frictionally engaged with the exterior surface 334 of the piston 300. The inner peripheral edge 336 is moveable relative to the exterior surface 334 in an axial direction parallel to the longitudinal axis in response to the a force applied by the biasing member 342 and retainer 344 that is greater than the frictional force applied to the inner peripheral edge by the exterior surface of the piston.

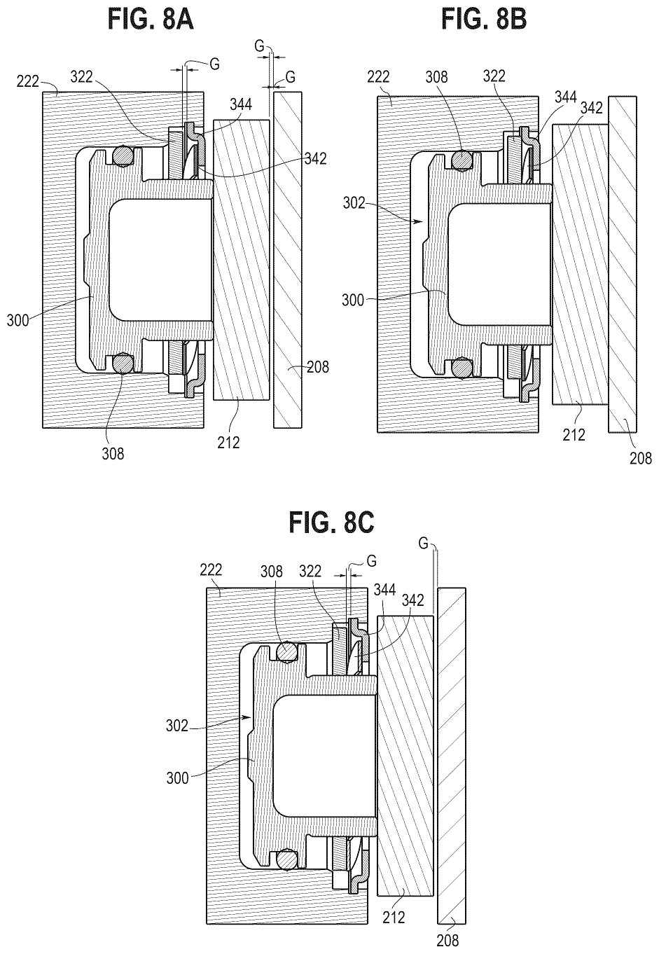

Referring to FIGS. 8A-C, the operation of the brake system during a normal braking operation is shown. In the initial state, shown in FIG. 8A, a gap (G) exists between the face 348 of the gripping member 322, e.g., the outer diametrical region of the gripping member, and the outer diametrical region, or edge portion 362, of the retainer 344. A similar size gap (G) exists between the brake pad 212 and rotor 208. When the brake lever 218 is engaged, the lever piston displaces the fluid 312 through the brake system, causing the caliper piston 300 to be pushed axially in the cavity 302, or bore. As shown in FIG. 8B, the gripping member 322 is moved with the piston 300 in the axial direction 8 to the braking position, due to the frictional interface between the gripping member 322 and the piston 300. The movement of the gripping member 322 in the axial direction, driven by the frictional engagement with the piston 300, compresses or otherwise deforms and/or displaces the biasing member 342. The gripping member 322 will continue to move with the piston 300 until the gap (G) is closed. Once contact is made between the gripping member 322 and the retainer 344, the gripping member 322 is no longer moved in the axially direction. At the same time, the pressure from the fluid 312 against the face 314 of the piston 300 results in a force transferred through the piston 300, to the brake pad 212 and then to the rotor 208. This normal force creates a frictional force between the pad 212 and the rotor 208, resulting in the braking function. When the brake lever 218 is released, as shown in FIG. 8C, the biasing member 342 expands, or displaces the gripping member 322 and piston 300 into the cavity of the caliper housing axially away from the brake pads 212 and rotor 208. The gripping member 322, which is frictionally engaged with the piston 300, pulls or retracts the piston 300 into the cavity 302 to the non-braking position, wherein the gripping member 322 engages or abuts the stop 324. At this point, the same gap (G) is maintained between the gripping member 322 and the retainer 344 and between the pad 212 and the rotor 208.

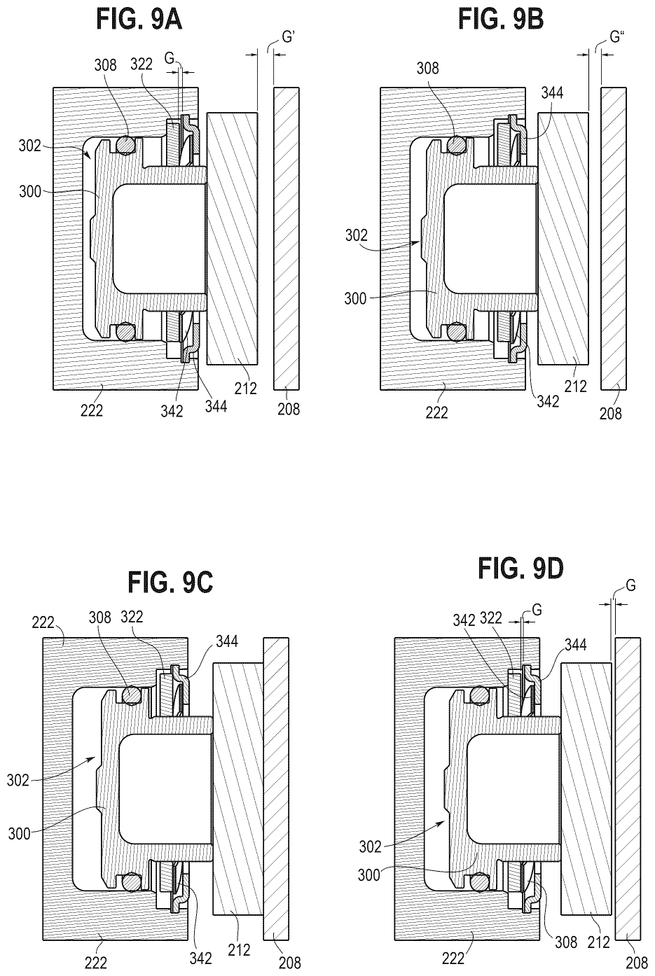

Referring to FIGS. 9A-D, due to pad wear or other anomalies, the gap (G) between the gripping member 322 and the retainer 344 may not be the same as the gap (G′) between the brake pad 212 and the rotor 208 when the piston is in the non-braking position. The system, however, provides for automatic adjustment to equalize the gaps. As shown in FIG. 9A, the initial gap (G′) between the pad 212 and the rotor 208 is greater than the gap (G) between the gripping member 322 and the retainer 344 when the piston 300 is in an initial, non-braking position. The brake lever 218 is pulled, causing fluid 312 displacement in the brake system. This causes the caliper piston 300 to move axially in the cavity. The gripping member 322 is moved with the piston 300 due to the frictional interface between those components. The gripping member 322 engages and compresses the biasing member 342, which resists the axial movement until the gripping member 322 engages the retainer 344, as shown in FIG. 9B. In this position, the gap (G) has been fully closed, but a gap (G″) between the pad 212 and the rotor 208 remains. At this point, the force acting on the piston 300 from the fluid 312 exceeds the friction force between the gripping member 322 and the piston 300, resulting in the piston 300 sliding in the axial direction 8 relative to the gripping member 322. The piston 300 continues to slide axially relative to the gripping member 322 until the pad 212 makes contact with the rotor 208 at a braking position, and the fluid pressure results in a force being transferred through the piston 300 and pad 212 into the rotor 208. That force creates the frictional interface between the pad and rotor, resulting in braking function, as shown in FIG. 9C. Once the brake lever 218 is released, as shown in FIG. 9D, the biasing member 342 expands and moves the gripping member 322 and piston 300 axially in the cavity 302 until the gripping member 322 engages the stop 324. The piston 300 is retracted and pulled into the cavity 302 by the frictional interface with the gripping member 322. In the non-braking position, the gap (G) between the gripping member 322 has now been equalized with the gap between the rotor 208 and the brake pad 212.

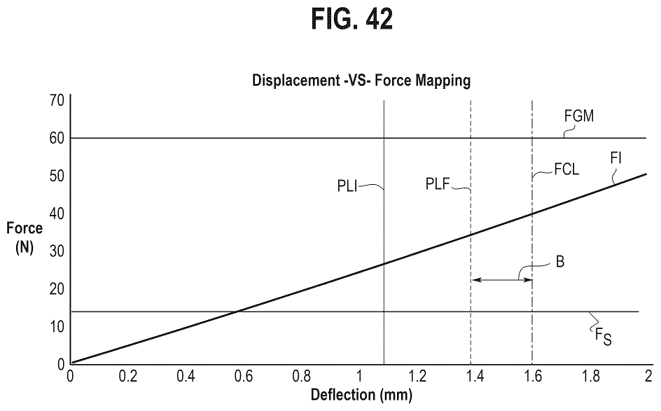

Referring to FIG. 42, a graph illustrates the interaction of different forces applied by various components. Displacement, or deflection, of the biasing member 342 in the axial direction 8 is plotted along the x-axis. The force (F) applied by the biasing member 342, configured as a wave spring in one embodiment, at the key frictional interfaces are plotted along the y-axis. The seal 308 interface between piston 300 and bore, or cavity 302, has some amount of friction (FS) resisting the axial movement of the piston 300, which will vary due to multiple factors. The maximum expected friction applied by the seal 308 is shown, since the rollback mechanism must be sufficiently strong enough to overcome this friction. A minimum gripping member 322 friction (FGM) interface with the piston 300 must be sufficiently higher than all other forces within the rollback mechanism. The reaction force of the biasing member 322 increases linearly as the deflection of the spring is increased. Within the normal range of operation, the spring force must stay roughly equally disposed between (i.e., below) the gripping member 322 friction force and (i.e., above) the seal 308 friction force for proper rollback function. The biasing member 342 may have an initial preload (PLI) applied by the retainer 344 before the brake is engaged, e.g., in a pre-braking position, and a final preload (PLF) when the brake is engaged, i.e., when the gap (G) between the gripping member 322 and the retainer 344 has been fully closed. The spring forces, between the initial and final preload, are maintained below the friction limit between the gripping member 322 and the piston 300 and above the friction limit of the seal 308 and piston 300, both with a reasonable buffer to accommodate variation. A displacement required to fully compress the biasing member 342, for example by compressing the wave spring to the thickness of the spring material stock, is shown as a fully compressed limit (FCL). Due to twisting of the spring material stock, the spring reaction will actually begin to increase rapidly before the spring is fully compressed, so a buffer (B) is maintained between the final preload value (PLF) and the fully compressed limit (FCL) to avoid the piston 300 sliding on the gripping member 322 before the gap (G) is fully closed.

In one embodiment, it may be desirable to minimize the axial stack-up of the components. At the same time, it may be desirable to minimize the diametrical envelope of the components. In one embodiment, this may be accomplished by forming the piston 300 with two differently sized diametrical portions, as shown in FIGS. 2-9D, which allows sufficient space to house and tune the retainer 344, biasing member 342, and gripping member 322 to function properly. The larger diameter of the piston is at the bottom of the cavity, which is captured by the rollback components. This means that the piston 300 cannot be pushed out of the cavity 302 without first dislodging the rollback components (e.g., retainer 344), which helps reduce the chances of a user accidentally dislodging and losing a piston 300.

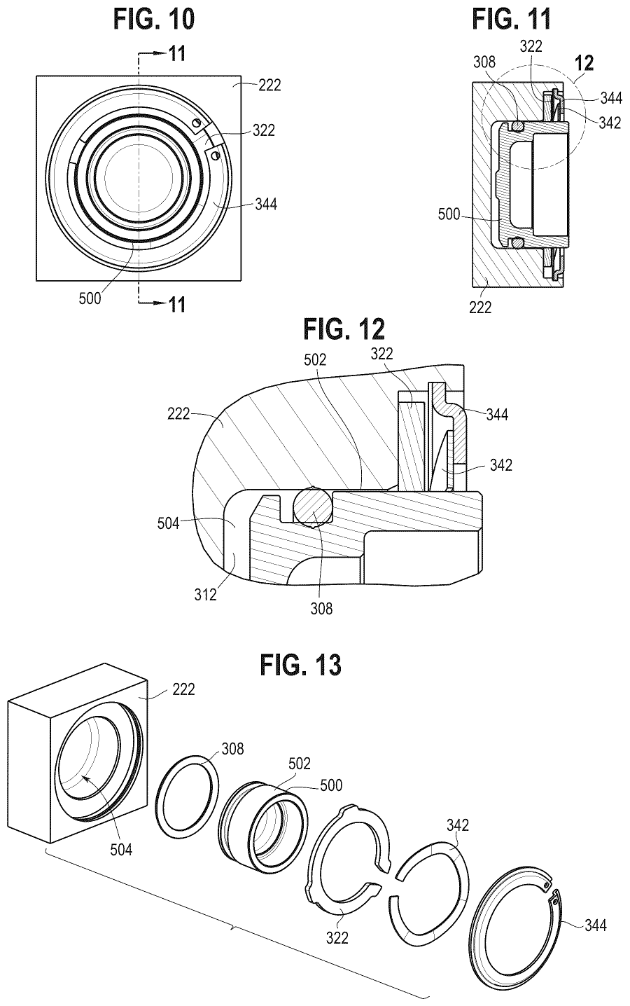

Referring to FIGS. 10-13, an embodiment of a piston 500 with a single diametrical section is shown. Rather the piston has a single exterior surface 502, with the size and diameter of the corresponding gripping member 322, biasing member 342 and retainer 344 being adjusted to accommodate the larger diameter of the exterior surface 502 of the piston 500. The cavity 504 of the caliper housing may be increased to accommodate the components, with the overall envelope of the caliper housing being increased.

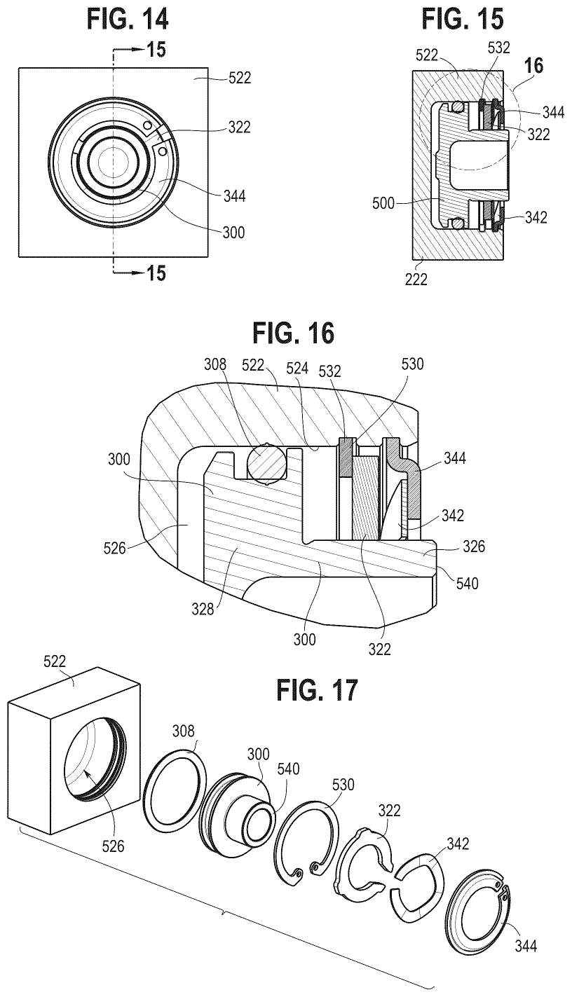

Referring to FIGS. 14-17, the caliper housing 522 has a cavity 526 configured with a single diameter exterior surface 524, while the piston 300 has differently sized first and second portions 328, 330. In this embodiment, the overall envelope of the caliper housing may be reduced. The stop may be configured as a stopper ring 530, installed in a circumferential groove 532, rather than as an integrally formed wall. The stopper ring 530 may be a split ring, such that the ring may be expanded and snapped into position during assembly. The stopper ring 530 functions to limit the axial movement of the gripping member 322 in the cavity 526 as the piston is moved to the non-braking position. The cross-sectional size of the piston end 540 engaging the pad 212 may be correspondingly reduced.

Referring to FIGS. 3B and 17-20, the caliper 600 is configured with a plurality of pistons 300, shown as two. The configuration of the rollback mechanism is the same as shown in FIGS. 4-9D, but the gripping member 622 may span or extend between the pistons, forming an S shape in one embodiment. In this embodiment, the gripping members may be integrally formed as a single component. The caliper 600 includes a housing 620 having a pair of laterally spaced cavities 304, which may be in liquid communication via cavity 604, positioned side-by-side and both defining longitudinal axes. The housing, pistons and other components may be configured in the same way as calipers having single opposing pistons as herein disclosed. Because the gripping member 622 couples the two adjacent, laterally spaced pistons 300 together, the rollback motion of the adjacent pistons on one side of the brake pad 212 will be more closely matched. In another embodiment, shown in FIG. 3D, the pistons 300 may be engaged by independent gripping members 322.

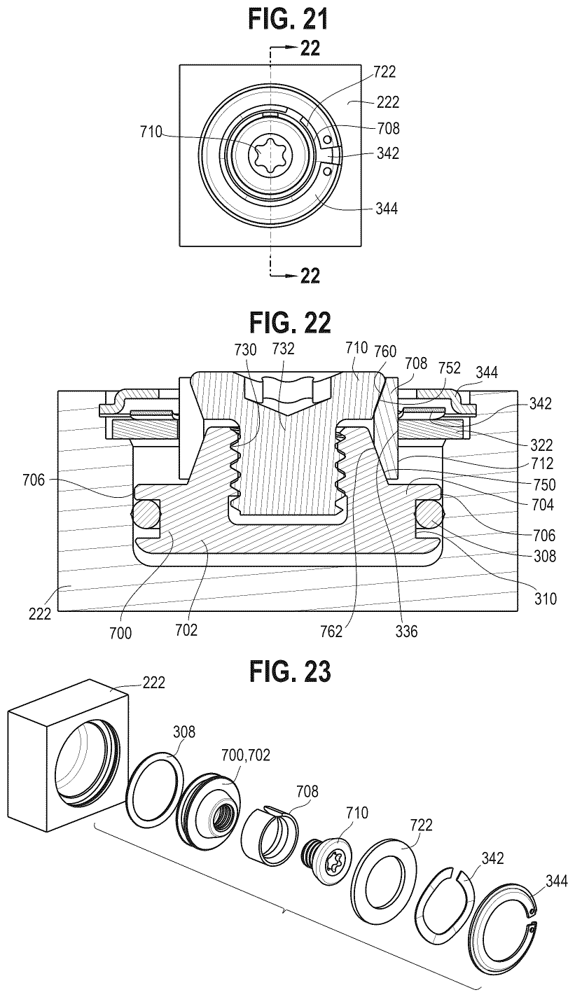

Referring to FIGS. 21-23, the gripping member 722 is configured as a solid ring without a split. In this embodiment, the piston 700 includes three components, including a main body 702 defining the first portion 704 with a first exterior surface 706 and the seal gland 310, an expansion ring 708 and an expander 710. The expansion ring 708 surrounds a portion of the main body, and may be a split ring such that the outer diameter of the expansion ring may be increased. The expander 710 is coupled to the main body and is movably engaged with the expansion ring 708, for example in an axial direction. The expansion ring 708 defines the second exterior surface 712 of the second portion, wherein the expander 710 is moveable relative to the main body 702 between at least first and second positions, and wherein an outer diameter of the expansion ring 708 is expandable between a first diameter and a second diameter as the expander 710 is moved between at least the first and second positions. The first diameter is different than the second diameter. In one embodiment, the expander 710 is axially moveable relative to the main body 702, for example by a threadable engagement between a threaded opening 730 in the main body and a threaded shaft 732 of the expander 710. The main body 702 includes a tapered section having a tapered surface 750. The expansion ring has a pair of tapered surfaces engaged by and sliding relative to the tapered surface 750 of the main body 702 and a tapered surface 752 formed by a head portion of the expander 710, configured as a bolt in one embodiment. A pair of angled tapered surfaces 760, 762 of the expansion ring are engaged by the tapered surface 752 of the main body and the tapered surface 750 of the expander. As the bolt is rotated, or expander 710 axially moved, the tapered surfaces 750, 752 are moved axially toward each other, thereby creating a wedging action to expand the expansion ring 708 radially outwardly against the inner peripheral, circumferential edge 336 of the gripping member, thereby creating friction. By adjusting the axial position of the expander 710, via an applied torque on the bolt, the amount of friction between the gripping member 322 and the piston 700 may be adjusted.

Referring to FIGS. 24-27, the retainer 344 is configured with external threaded portion 358 that interface with the threads 360 formed in the exterior surface of the larger portion of the cavity. The axial position of the retainer 344 may be adjusted by rotating or threadably engaging the retainer. In this way, the retainer 344 may be fully or only partially threaded into the caliper, which will change the resulting rollback quantity and the preloading of the biasing member.

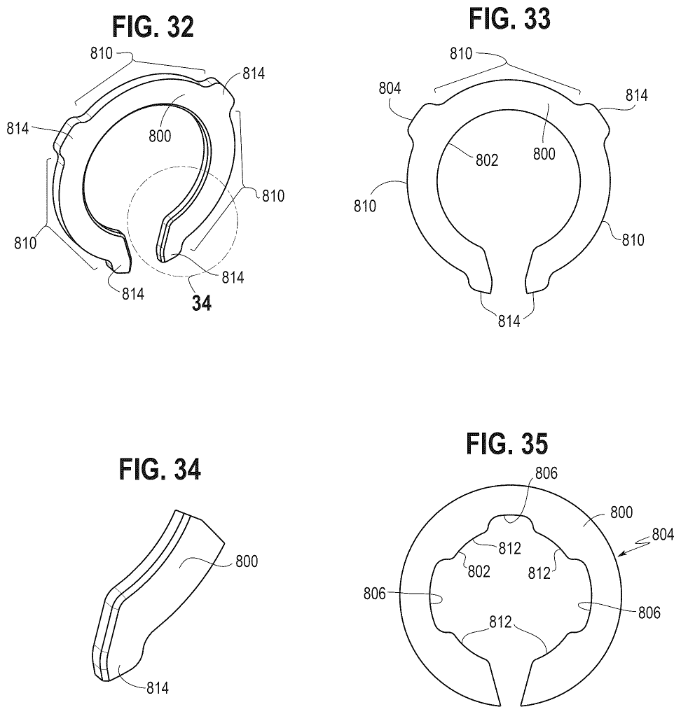

In the various embodiments, the sealing interface and the gripping interface are independent, or spaced apart. The inner circumferential edge 336 of the gripping member may be rounded or chamfered, as shown for example in FIGS. 32 and 34, to reduce scoring or marring of the piston exterior surface.

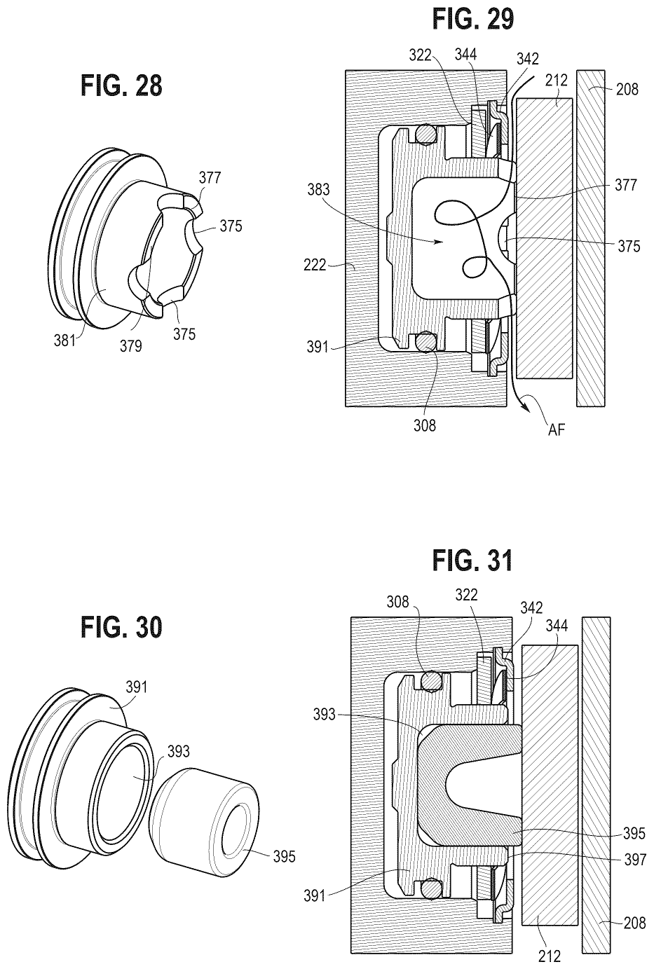

Metal pistons may have higher heat transfer rates compared to molded phenolic pistons. The reduced diameter and associated contact surface area of the piston end 331, however, effectively reduces the contact area with the brake pad 212, which may reduce heat transfer from the brake pad 212 to the piston 300. The contact area of the piston may be further reduced by adding channel features 375 on the piston end. In one embodiment, shown in FIGS. 28 and 29, an end of the piston 381 is configured with a circular rim 379 having at least one ventilation channel 375 formed in the rim, forming a plurality of contact tabs or pads 377. The rim may have a plurality of channels, shown for example and without limitation as four (4) channels. The ventilation channels provide for air flow (AF) within an inner cavity 383 of the piston 381, further assisting in cooling of the system.

Referring to FIGS. 30 and 31, the piston 391 defines an interior cavity 393. An insulator 395 is disposed in the interior cavity 393. The insulator 395 extends axially outwardly from interior cavity 393 of the piston past an endmost portion 397 of the piston. The length of the piston 391 may be reduced such that the insulator 395 is the only component contacting the pad 212, thereby mitigating heat transfer. The insulator 395 may be configured with a cavity defining a rim, thereby further reducing the contact area with the brake pad 212.

The smaller dimeter of the piston end 331 also increases the space available in the pad pocket, or open area adjacent the pads 212, for air flow and exposing a larger area of the pad, for example a backing plate, to air flow. Both of these factors may improve the overall thermal performance of the system. Moreover, since the seal 308 is installed closer to the face 314 than the end 331, there is greater opportunity for heat energy to be dissipated from the system before the heat transferred to the piston 300 reaches the seal 308, with any attendant degradation of the material forming the seal (i.e. heat/compression set).

Referring to FIGS. 32-35, the gripping member 800, configured as a ring in one embodiment, has an outer peripheral edge or shape sufficiently large enough to contact the retainer 344, while the inner peripheral edge 802 contacts the piston 300 to create the frictional interface. The inner and outer peripheral edges 802, 804 may be configured with one or more notches 806, 810, which define gripping tabs 812 or force receiving tabs 814. The size, shape and number of the notches, or tabs, allow an operator to tune the frictional force applied by the gripping member.

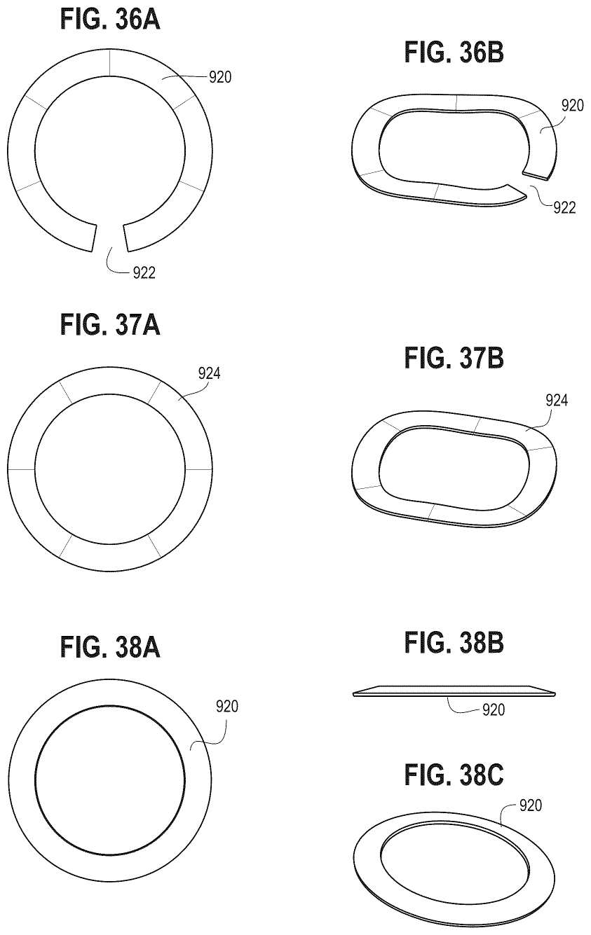

Referring to FIGS. 36A-38C, the biasing member 342 may be configured as different springs. In one embodiment, shown in FIGS. 36A and 36B, the spring 920 is configured as an edge wound wave spring with a split 922. This is advantageous because spring parameters can be changed without requiring manufacturing tool changes. As shown in FIGS. 37A and 37B, the spring is configured as a solid wave spring 924, which is formed from a flat ring of material using a die. Referring to FIGS. 38A-C, the spring is configured as a Belleville style spring 926.

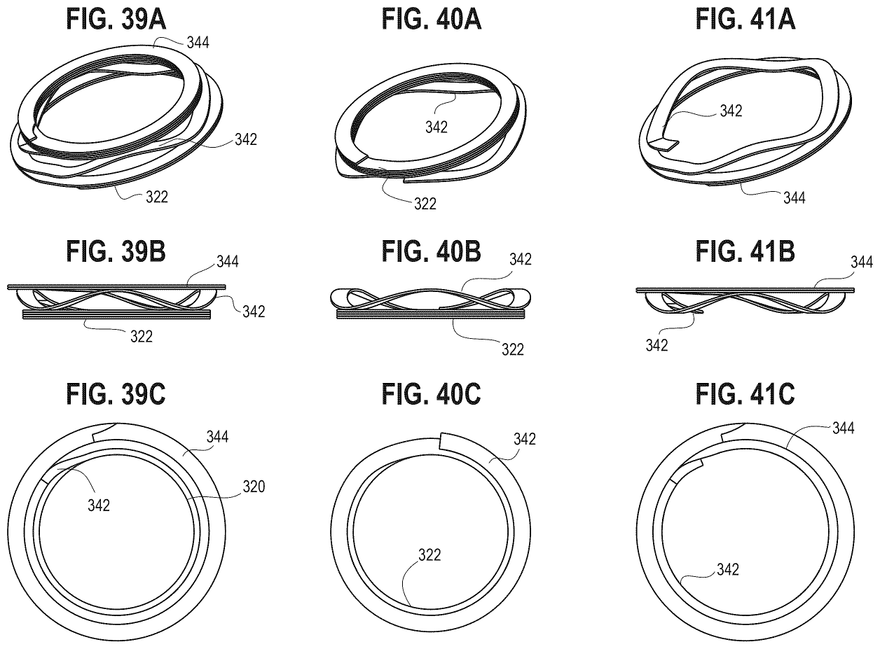

Referring to FIGS. 39A-41C, the gripping member 322, biasing member 342 and/or retainer 344 may be integrally formed, which reduces the part count of the system. The wave spring is typically made by a CNC edge rolling and forming process. Using this process, the gripping member 322, retainer 344 and biasing member 342 may be integrally formed as shown in FIGS. 39A-C, the gripping member 322 and biasing member 342 may be integrally formed as shown in FIGS. 40A-C, or the biasing member 342 and retainer 344 may be integrally formed as shown in FIGS. 41A-C.

Example systems, apparatus, method and articles of manufacture for bicycles (and/or other vehicles) are disclosed herein. Examples and combinations of examples disclosed herein include the following:

Example 1 is a brake caliper comprising a caliper housing comprising a cavity defining a longitudinal axis. A piston is disposed in the cavity and reciprocally movable in the cavity along the longitudinal axis between a braking position and a non-braking position. A seal is disposed between the piston and the caliper housing. A gripping member is engaged the piston and longitudinally spaced from the seal. The gripping member is reciprocally movable with the piston along the longitudinal axis. A retainer is connected to the caliper housing and longitudinally spaced from the gripping member. The retainer retains the gripping member within the cavity. A biasing member is disposed between the retainer and the gripping member. The biasing member biases the gripping member towards the non-braking position.

Example 2 includes the brake caliper of Example 1, wherein the gripping member and the biasing member are metal and the seal comprises an elastomeric material.

Example 3 includes the brake caliper of any of Examples 1 and 2, wherein the gripping member is slidably engaged with the piston.

Example 4 includes the brake caliper of any of Examples 1-3, wherein the caliper housing comprises a stop oriented transverse to the longitudinal axis. The gripping member abuts the stop when the piston is in the non-braking position.

Example 5 includes the brake caliper of any of Examples 1-4, wherein the cavity defines an interior surface and the piston comprises an exterior surface, a first portion and a second portion. The seal is disposed between the exterior surface of the first portion of the piston and the interior surface of the cavity. The gripping member is engaged with the second portion of the piston.

Examples 6 includes the brake caliper of any of Examples 1-5, wherein the gripping member comprising an inner peripheral edge engaged with the exterior surface of the piston and a face. The face abuts the stop when the piston is in the non-braking position and the face is spaced apart from the stop when the piston is in the braking position.

Example 7 includes the brake caliper of any of Examples 1-6, wherein the caliper housing comprises a radially extending slot. The retainer comprises an outer peripheral edge disposed in the slot, and the retainer comprises an inner peripheral edge spaced apart from the exterior surface of the piston.

Example 8 includes the brake caliper of any of Examples 1-7, wherein the retainer is threadably engaged with the caliper housing.

Example 9 includes the brake caliper of any of Examples 1-8, wherein the inner peripheral edge is frictionally engaged with the exterior surface of the piston. The inner peripheral edge is moveable relative to the exterior surface in an axial direction parallel to the longitudinal axis in response to the application of a frictional force applied to the inner peripheral edge by the exterior surface of the piston in opposition to a normal force applied to the gripping member by the retainer.

Example 10 includes the brake caliper of any of Examples 1-9, wherein the biasing member comprises a wave spring.

Example 11 includes the brake caliper of any of Examples 1-10, wherein the cavity of the caliper housing has a first portion and a second portion. An interior surface of the cavity comprises a first interior surface defined by the first portion and a second interior surface defined by the second portion. The first interior portion has a first diameter less than a second diameter of the second portion. The seal is disposed between an exterior surface of the piston and the interior surface of the first portion and the gripping member is disposed in the second portion.

Example 12 includes the brake caliper of any of Examples 1-11, wherein the second portion of the cavity comprises a wall defining a stop oriented transverse to the longitudinal axis.

Examples 13 includes the brake caliper of any of Examples 1-12, wherein the piston has a first portion having a first diameter and a second portion having a second diameter, and wherein an exterior surface of the piston comprises a first exterior surface defined by the first portion and a second exterior surface defined by the second portion, wherein the first portion has a first diameter greater than a second diameter of the second portion, and wherein the seal is disposed between the first exterior surface and the interior surface, and the gripping member engages the second exterior surface.

Example 14 includes the brake caliper of any of Examples 1-13, wherein the piston comprises a main body defining the first portion, an expansion ring surrounding a portion of the main body and an expander coupled to the main body and movably engaged with the expansion ring. The expansion ring defines the second exterior surface of the second portion. The expander is moveable relative to the main body between at least first and second positions. An outer diameter of the expansion ring is expandable between a first diameter and a second diameter as the expander is moved between at least the first and second positions. The first diameter is different than the second diameter.

Example 15 includes the brake caliper of any of Examples 1-14, wherein the stop comprises a stop ring having a peripheral edge disposed in a radially extending slot formed in the caliper housing.

Example 16 includes the brake caliper of any of Examples 1-15, wherein the piston comprises an end portion configured to engage a brake pad, wherein the end portion comprises a circular rim having at least one ventilation channel formed in the rim.

Examples includes the brake caliper of any of Examples 1-16, wherein the piston defines an interior cavity, and further comprising an insulator disposed in the interior cavity, wherein the insulator extends outwardly from interior cavity of the piston past an endmost portion of the piston.

Example 18 includes the brake caliper of Example 1, wherein the cavity comprises first and second laterally spaced cavities, each defining first and second interior surfaces and first and second longitudinal axes respectively. The stop comprises first and second stops oriented transverse to the first and second longitudinal axes. The piston comprises first and second pistons disposed in the first and second cavities. The first and second pistons are reciprocally moveable in the first and second cavities relative to the caliper housing along the first and second longitudinal axes between the non-braking position and the braking position. The seal comprises first and second seals disposed between first and second exterior surfaces of each of the first and second pistons and the first and second interior surfaces of the first and second cavities. The gripping member comprises first and second gripping members comprising first and second inner peripheral edges engaged with first and second exterior surfaces of the first and second pistons. First and second outer peripheral edges are spaced apart from the first and second interior surfaces of the first and second cavities and first and second faces abut the first and second stops when the first and second pistons are in the non-braking position. The first and second faces are spaced apart from the first and second stops when the first and second pistons are in the braking position. The biasing member comprises first and second biasing members biasing the first and second gripping members and first and second pistons respectively from the braking position to the non-braking position.

Example 19 including the brake caliper of Example 18, wherein the first and second gripping members are integrally formed as a single component.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

Although embodiments have been described for illustrative purposes, those skilled in the art will appreciate that various modifications, additions, and substitutions are possible, without departing from the scope and spirit of the disclosure. It is therefore intended that the foregoing description be regarded as illustrative rather than limiting, and that it be understood that all equivalents and/or combinations of embodiments and examples are intended to be included in this description.

Although certain parts, components, features, and methods of operation and use have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A brake caliper comprising:
a caliper housing comprising a cavity defining a longitudinal axis;
a piston disposed in the cavity and reciprocally movable in the cavity along the longitudinal axis between a braking position and a non-braking position;
a seal disposed between the piston and the caliper housing;
a gripping member engaged with the piston and longitudinally spaced from the seal, the gripping member reciprocally movable with the piston along the longitudinal axis;
a retainer connected to the caliper housing and longitudinally spaced from the gripping member, the retainer retaining the gripping member within the cavity; and
a biasing member disposed between the retainer and the gripping member, the biasing member biasing the gripping member towards the non-braking position.

2. The brake caliper of claim 1, wherein the gripping member and the biasing member are metal and the seal comprising an elastomeric material.

3. The brake caliper of claim 1, wherein the gripping member is slidably engaged with the piston.

4. The brake caliper of claim 1, wherein the caliper housing comprises a stop oriented transverse to the longitudinal axis, the gripping member abutting the stop when the piston is in the non-braking position.

5. The brake caliper of claim 4, wherein the cavity defines an interior surface and the piston comprises an exterior surface, a first portion and a second portion, the seal disposed between the exterior surface of the first portion of the piston and the interior surface of the cavity, the gripping member engaged with the second portion of the piston.

6. The brake caliper of claim 5, wherein the gripping member comprising an inner peripheral edge engaged with the exterior surface of the piston and a face, wherein the face abuts the stop when the piston is in the non-braking position and wherein the face is spaced apart from the stop when the piston is in the braking position.

7. The brake caliper of claim 5, wherein the caliper housing comprises a radially extending slot, wherein the retainer comprises an outer peripheral edge disposed in the slot, and wherein the retainer comprises an inner peripheral edge spaced apart from the exterior surface of the piston.

8. The brake caliper of claim 1, wherein the retainer is threadably engaged with the caliper housing.

9. The brake caliper of claim 7, wherein the inner peripheral edge is frictionally engaged with the exterior surface of the piston, wherein the inner peripheral edge is moveable relative to the exterior surface in an axial direction parallel to the longitudinal axis in response to the application of a frictional force applied to the inner peripheral edge by the exterior surface of the piston in opposition to a normal force applied to the gripping member by the retainer.

10. The brake caliper of claim 1, wherein the biasing member comprises a wave spring.

11. The brake caliper of claim 1 wherein the cavity of the caliper housing has a first portion and a second portion, and wherein an interior surface of the cavity comprises a first interior surface defined by the first portion and a second interior surface defined by the second portion, wherein the first interior portion has a first diameter less than a second diameter of the second portion, wherein the seal is disposed between an exterior surface of the piston and the interior surface of the first portion and the gripping member is disposed in the second portion.

12. The brake caliper of claim 10, wherein the second portion of the cavity comprises a wall defining a stop oriented transverse to the longitudinal axis.

13. The brake caliper of claim 1, wherein the piston has a first portion having a first diameter and a second portion having a second diameter, and wherein an exterior surface of the piston comprises a first exterior surface defined by the first portion and a second exterior surface defined by the second portion, wherein the first portion has a first diameter greater than a second diameter of the second portion, and wherein the seal is disposed between the first exterior surface and the interior surface, and the gripping member engages the second exterior surface.

14. The brake caliper of claim 13, wherein the piston comprises a main body defining the first portion, an expansion ring surrounding a portion of the main body and an expander coupled to the main body and movably engaged with the expansion ring, wherein the expansion ring defines the second exterior surface of the second portion, wherein the expander is moveable relative to the main body between at least first and second positions, and wherein an outer diameter of the expansion ring is expandable between a first diameter and a second diameter as the expander is moved between at least the first and second positions, wherein the first diameter is different than the second diameter.

15. The brake caliper of claim 4, wherein the stop comprises a stop ring having a peripheral edge disposed in a radially extending slot formed in the caliper housing.

16. The brake caliper of claim 1, wherein the piston comprises an end portion configured to engage a brake pad, wherein the end portion comprises a circular rim having at least one ventilation channel formed in the rim.

17. The brake caliper of claim 1, wherein the piston defines an interior cavity, and further comprising an insulator disposed in the interior cavity, wherein the insulator extends outwardly from interior cavity of the piston past an endmost portion of the piston.

18. The brake caliper of claim 1, wherein the cavity comprises first and second laterally spaced cavities, each defining first and second interior surfaces and first and second longitudinal axes respectively, and wherein the stop comprises first and second stops oriented transverse to the first and second longitudinal axes;
wherein the piston comprises first and second pistons disposed in the first and second cavities, wherein the first and second pistons are reciprocally moveable in the first and second cavities relative to the caliper housing along the first and second longitudinal axes between the non-braking position and the braking position;
wherein the seal comprises first and second seals disposed between first and second exterior surfaces of each of the first and second pistons and the first and second interior surfaces of the first and second cavities;
wherein the gripping member comprises first and second gripping members comprising first and second inner peripheral edges engaged with first and second exterior surfaces of the first and second pistons, first and second outer peripheral edges spaced apart from the first and second interior surfaces of the first and second cavities and first and second faces abutting the first and second stops when the first and second pistons are in the non-braking position, and wherein the first and second faces are spaced apart from the first and second stops when the first and second pistons are in the braking position; and
wherein the biasing member comprises first and second biasing members biasing the first and second gripping members and first and second pistons respectively from the braking position to the non-braking position.

19. The brake caliper of claim 18, wherein the first and second gripping members are integrally formed as a single component.
